(19) United States
(12) Patent Application Publication
(10) Pub. No.: US 2025/0209269 A1
(43) Pub. Date: Jun. 26, 2025

(54) Stateful Text Generation Using Large Language Models

(71) Applicant: Study Genie, Inc., Freemont, CA (US)

(72) Inventor: Sarvesh Bhardwaj, Fremont, CA (US)

(21) Appl. No.: 18/991,618

(22) Filed: Dec. 22, 2024

Related U.S. Application Data
(60) Provisional application No. 63/614,485, filed on Dec. 22, 2023.

(51) Int. Cl. G06F 40/279; G06F 40/40; G09B 7/00

(52) U.S. Cl. CPC G06F 40/279; G06F 40/40; G09B 7/00

(57) ABSTRACT

Systems and methods for stateful text generation using large language models are described. For example, a method may include inputting a first prompt to a large language model to cause the large language model to output a list of keywords based on a context window; inputting a second prompt to the large language model to cause the large language model to output an adjacency matrix for keywords in the list of keywords that indicates which of the keywords in the list of keywords are related in the context window; and determining a graph including nodes corresponding to respective keywords in the list of keywords and edges corresponding to relationships between keywords indicated by the adjacency matrix.

### CROSS-REFERENCE TO RELATED APPLICATION(S)

This application claims the benefit of U.S. Provisional Application No. 63/614,485, filed on Dec. 22, 2023, which is incorporated herein by reference in its entirety.

### TECHNICAL FIELD

This disclosure relates to stateful text generation using large language models.

### BACKGROUND

Large Language Models (LLMs), which are advanced forms of artificial intelligence, specialize in processing and generating human-like text. They are designed to understand context, make predictions, and assist in a variety of applications across numerous industries such as technology, healthcare, education, and finance. LLMs can effectively handle tasks that include composing and comprehending text, providing customer service through chatbots, and even aiding in complex problem-solving. These models can operate on both centralized servers and individual devices, enabling them to deliver tailored content and answers to user inquiries in real-time.

### SUMMARY

Disclosed herein are implementations of stateful text generation using large language models.

In a first aspect, the subject matter described in this specification can be embodied in systems that include a memory, and a processor, wherein the memory includes instructions executable by the processor to cause the system to: input a first prompt to a large language model to cause the large language model to output a list of keywords based on a context window; input a second prompt to the large language model to cause the large language model to output an adjacency matrix for keywords in the list of keywords that indicates which of the keywords in the list of keywords are related in the context window; and determine a graph including nodes corresponding to respective keywords in the list of keywords and edges corresponding to relationships between keywords indicated by the adjacency matrix.

In a second aspect, the subject matter described in this specification can be embodied in methods that include inputting a first prompt to a large language model to cause the large language model to output a list of keywords based on a context window; inputting a second prompt to the large language model to cause the large language model to output an adjacency matrix for keywords in the list of keywords that indicates which of the keywords in the list of keywords are related in the context window; determining a graph including nodes corresponding to respective keywords in the list of keywords and edges corresponding to relationships between keywords indicated by the adjacency matrix; and storing, displaying, or transmitting the graph.

In a third aspect, the subject matter described in this specification can be embodied in a non-transitory computer-readable storage medium. The non-transitory computer-readable storage medium may include executable instructions that, when executed by a processor, cause performance of operations, comprising operations to: input a first prompt to a large language model to cause the large language model to output a list of keywords based on a context window; input a second prompt to the large language model to cause the large language model to output an adjacency matrix for keywords in the list of keywords that indicates which of the keywords in the list of keywords are related in the context window; and determine a graph including nodes corresponding to respective keywords in the list of keywords and edges corresponding to relationships between keywords indicated by the adjacency matrix.

In a fourth aspect, the subject matter described in this specification can be embodied in systems that include a memory, and a processor, wherein the memory includes instructions executable by the processor to cause the system to: access a graph including nodes corresponding to respective keywords in a list of keywords and edges corresponding to relationships between keywords in a context window; select a set of distinct tuples of keywords corresponding to different paths through the graph, wherein each tuple of keywords includes the respective keywords corresponding to nodes of a path in the graph that passes through up to M nodes, where M is an integer; and input prompts, which each include the keywords in a tuple of keywords from the set of distinct tuples of keywords, to a large language model to cause the large language model to output texts.

In a fifth aspect, the subject matter described in this specification can be embodied in methods that include accessing a graph including nodes corresponding to respective keywords in a list of keywords and edges corresponding to relationships between keywords in a context window; selecting a set of distinct tuples of keywords corresponding to different paths through the graph, wherein each tuple of keywords includes the respective keywords corresponding to nodes of a path in the graph that passes through up to M nodes, where M is an integer; inputting prompts, which each include the keywords in a tuple of keywords from the set of distinct tuples of keywords, to a large language model to cause the large language model to output texts; and storing, displaying, or transmitting the texts.

In a sixth aspect, the subject matter described in this specification can be embodied in a non-transitory computer-readable storage medium. The non-transitory computer-readable storage medium may include executable instructions that, when executed by a processor, cause performance of operations, comprising operations to: access a graph including nodes corresponding to respective keywords in a list of keywords and edges corresponding to relationships between keywords in a context window; select a set of distinct tuples of keywords corresponding to different paths through the graph, wherein each tuple of keywords includes the respective keywords corresponding to nodes of a path in the graph that passes through up to M nodes, where M is an integer; and input prompts, which each include the keywords in a tuple of keywords from the set of distinct tuples of keywords, to a large language model to cause the large language model to output texts.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a system for stateful text generation using large language models to generate test questions for students in an educational course.

FIG. 2 is an illustration of an example of a graph that may be used for stateful text generation using large language models.

FIG. 3 is a block diagram of an example of a system for stateful text generation using large language models.

FIG. 4 is a block diagram of an example of a system for stateful text generation using a large language model and a database.

FIG. 5 is a block diagram of an example of a system for stateful text generation using large language models.

FIG. 6 is flowchart of an example of a technique for generating a knowledge graph indicating relationships amongst a list of keywords in a context using a large language model.

FIG. 7 is flowchart of an example of a technique for stateful text generation using a large language model and a knowledge graph indicating relationships amongst a list of keywords in a context.

FIG. 8 is flowchart of an example of a technique for selecting a path in a knowledge graph indicating relationships amongst a list of keywords in a context in order to select a tuple of keywords corresponding to the path.

FIG. 9 is flowchart of an example of a technique for selecting a set of distinct tuples of keywords that can be used with a large language model to generate a variety of texts that are relevant in a context.

FIG. 10 is flowchart of an example of a technique for selecting a reduced set of distinct tuples of keywords using k-means analysis.

FIG. 11 is flowchart of an example of a technique for selecting a reduced set of distinct tuples of keywords by removing tuples of keywords that are subsets of other tuples of keywords.

### DETAILED DESCRIPTION

Systems and methods for providing stateful text generation using large language models are disclosed. For example, a knowledge graph may be generated using a large language model and used to explore a keyword search space. A new approach is proposed to generate unique content across different large language model sessions by extracting knowledge relationships modeled in the large language model. The knowledge relationships may be modeled as a graph and each generation is mapped to a path in the graph thus identifying the generations uniquely. Since the number of paths in a graph can be exponential in the number of nodes, by using this mapping, explicit storage of the generations can be avoided, and the large language model may be invoked to generate unique output from any path traversal. Using this approach, the entire state-space of potential generations may be traversed and as many potential generations as the number of paths in the knowledge graph can be extracted. The number of different entities (nodes) and relationships (edges) that a large language model will provide may be determined in the beginning, and then this approach may be used to create generations that cover the entire resulting state-space of generations in the large language model.

Large Language Models are stateless entities. If a large language model is prompted to generate content on any topic today and if later prompt it to generate additional text on the topic in another session, there may be overlap between the previous text and new text. If unique and new text in subsequent sessions is desired, the full context of what the large language model had previously generated may need to be provided. This difficulty to produce unique and new results across different interactions with the same large language model is due to 1) large language models lacking memory, and 2) lack visibility into the knowledge relationships encoded within the large language model.

One application giving rise to a need for this unique ability is during generating of questions to help students practice for a topic in a course in an educational context. Conventional methods may lack control over how the large language model generates the questions and cannot guarantee that the questions generated in two different sessions will be different from each other. A new approach is described herein to generate unique questions across sessions by first extracting the relationship information that exists in the large language model. This relationship information may then be stored in an implicit representation outside of the large language model. Finally, the implicit representation may be explored to enumerate the state-space of the large language model and guide it to generate unique texts across sessions.

As used herein, the term “keyword” refers to a string of text that occurs in and/or relates to a context window (e.g., in one or more documents that are input to a context window) and is assessed, using a large language model, to have particular significance to that context window. For example, a keyword may include a sequence of one or more words, abbreviations, acronyms, or Chinese characters. Some implementations may place limits on the size of keywords in terms of a character count or a word count (e.g., limiting keywords to consisting of 1 or 2 words). For example, keywords in a given context may be determined by prompting a large language model to list keywords for the specified context window.

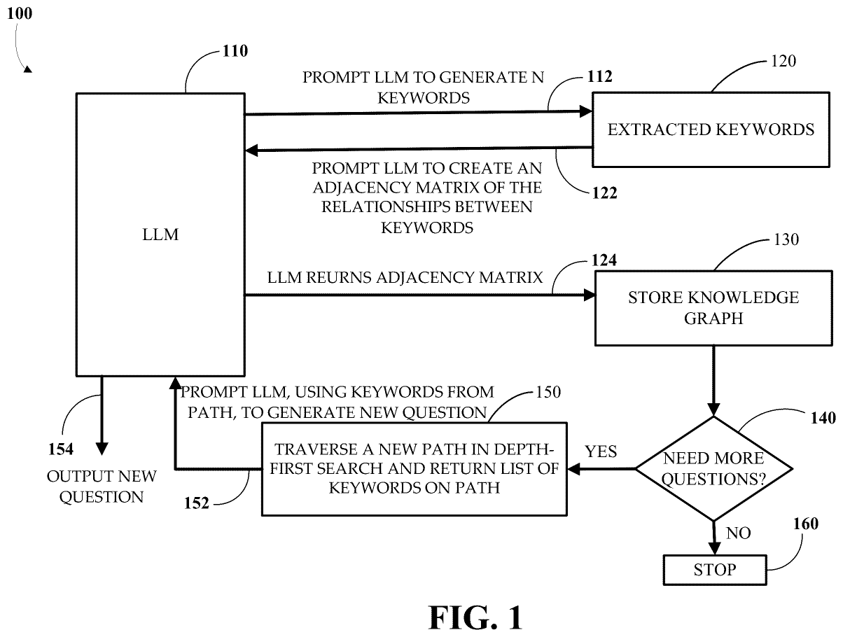

FIG. 1 is a block diagram of an example of a system 100 for stateful text generation using large language models to generate test questions for students in an educational course. The system 100 includes a large language model 110 that is used to generate test questions for a student in an education-based environment. The system 100 may be used to implement the following procedure.

First, a metric is selected based on which the generations (e.g., texts, such as test questions) will be ordered. For example, in this case questions are generated and the metric is “probability of occurring on an advanced placement (AP) exam”. For example, when asked to give the keywords for the topic of “Developments in South-East Asia” as part of the “The Global Tapestry” unit in the AP World History course, the large language model 110 may internally determine which keywords have higher probability of occurring in the AP World History exam and return “Song Dynasty” and “Mongol Empire” as some of the top few keywords.

Next, the large language model 110 may be prompted, at 112, to generate N keywords 120 based on decreasing order of the metric and the large language model 110 may be instructed to assign a value m_i corresponding to the metric to each keyword k_i.

Next, in order to identify relationships between the keywords 120, the large language model 110 is prompted, at 122, to generate an adjacency matrix between each of the keywords 122 to indicate if they are related to each other. For example, the adjacency matrix may be encoded as a list of adjacency lists for each of the keywords 120. So, in this example, if a keyword k_i is related to another keyword k_j, the large language model 110 will add k_j to k_i's adjacency list and vice versa. In some implementations, the adjacency matrix may be encoded as an N×N array, where each element is one or zero depending on whether the keyword correspond the row of the element and the keyword corresponding to column of the element are determined to be related by the large language model 110. In some implementations, the adjacency matrix may be encoded as an N×N array, where each element is a real number reflecting the nature of the relatedness of the keyword correspond the row of the element and the keyword corresponding to column of the element (e.g., the element value may be large if the keywords are strongly related and small if the keywords are weakly related), as determined by the large language model 110. In some implementations, elements on the diagonal of the adjacency matrix may ignored and/or omitted.

For example, one of the formats of the adjacency list could be as shown below:
“East Asia”: [“Song Dynasty”, “Mongol Empire”, “Yuan Dynasty”] (the relationships exist because Song Dynasty and Mongol Empire were in East Asia)
“Song Dynasty”: [“East Asia”, “Yuan Dynasty”, “Mongol Empire”] (the relationships exist because Song Dynasty was in East Asia and Yuan Dynasty succeeded Song Dynasty. Mongols conquered Song dynasty so they are related)
“Mongol Empire”: [“East Asia”, “Song Dynasty”, “Yuan Dynasty”] (Mongol Empire had a big impact on the Song Dynasty and Yuan Dynasty originated as part of Mongol Empire).
“Yuan Dynasty”: [“East Asia”, “Song Dynasty”, “Mongol Empire”]

At 124, the large language model 110 returns the adjacency matrix. Now, the information about relationships between the keywords 120 in the adjacency matrix (e.g., adjacency lists) can be used to represent the keyword relationships in the form of a graph 130. In the graph 130 each keyword corresponds to a node and an edge between node n_i and n_j exists if the keyword corresponding to n_i is related to keyword corresponding to node n_j. A path on the graph 130 corresponds to a set of related keywords. Also, the initial order of the nodes may impose a topological ordering of the nodes.

Once the graph 130 has been determined, at 140, the system 100 determines if there is a pending request for more test questions to be generated. If another question is needed, then, at 150, the graph may be traversed to select a new path using a depth-first search to return a list of nodes associated with respective keywords from along the new path. These respective keywords associated with the new path form a tuple of keywords that may be used to generate a new question using the large language model 110.

As an example of one method to create a generation from the large language model 110, paths of length m (where length corresponds to the number of nodes on the path) on the graph 130 may be enumerated starting from the lowest ordered node in the graph 130 in a Depth-First Search manner until a path of length “m” is selected.

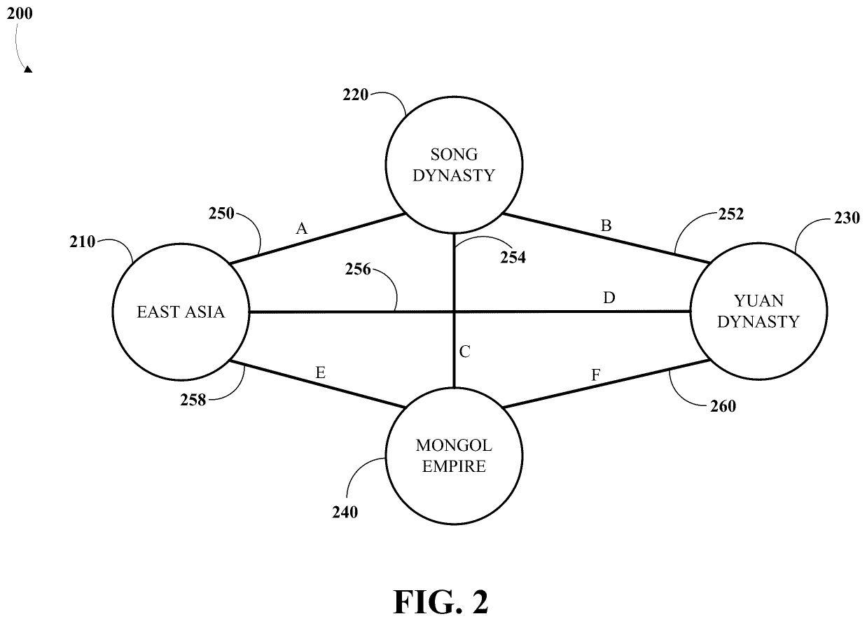

FIG. 2 is an illustration of an example of a graph 200 that may be used for stateful text generation using large language models. The graph 200 includes four nodes 210, 220, 230 and 240 and six edges 250, 252, 254, 256, 258, and 260 that connect the nodes pairwise.

In the graph 200, a path of length 3 may be traversed, at 150, from the East Asia node 210—the nodes on one of the paths would be “East Asia” 210, “Song Dynasty” 220, and “Yuan Dynasty” 230 with edge A 250 and edge B 252. Another path would be “East Asia” 210, “Song Dynasty” 220, and “Mongol Empire” 240 with edge A 250 and edge C 254.

Another approach to enumerate the m-tuples would be to start with the highest topological order node from which a path of length-m may be selected. For example, another path would start at the “Song Dynasty” node 220 and result in the path “Song Dynasty” 220, “Mongol Empire” 240, and “Yuan Dynasty” 230. Then, a lower topological order node (in this case “East Asia” 210) may be used as the starting point for selecting a path. From that node 210, other paths may be enumerated—e.g. “East Asia” 210, “Song Dynasty” 220 and “Mongol Empire” 240; and “East Asia” 210, “Mongol Empire” 240, and “Yuan Dynasty” 230.

At 152 a list of “m” respective keywords corresponding to a new path in the graph 130 is passed to the large language model 110 as part of a prompt to generate a question which relates to all the “m” respective keywords. At 154, the large language model 110 then outputs a new question. In some implementations, this new question generation process is repeated for all paths starting from node 210. Once all paths of length “m” from the node 210 have been enumerated, the node 210 may be marked as complete (e.g., marked using meta data in the graph 130 data structure). Once a node is marked complete, we move to the next node in the topological order (e.g., the next node in the list of the keywords generated by the large language model 110). This process may be repeated until 1) at 140, the required number of questions have been generated or 2) all nodes in the graph 130 have been marked complete. The process is completed and the resulting set of new questions may be returned to a user at 160.

Some implementations may use Alternative techniques to get m-tuples of keywords and track them. The method described above of getting the keywords first and then the adjacency matrix is an efficient approach to minimize the output tokens from the large language model consumed to extract the relationship information. There could be other approaches to get the m-tuples by directly prompting the large language model to return all the lists of m-tuples of keywords that are related to each other. This explicit enumeration by large language model could be expensive in terms of the output tokens as there could be combinations of m-keywords, where N is the number of keywords, which grows very rapidly with the number of keywords. In addition, because the large language model would have to keep track of generations, it might not be able to even enumerate all the combinations accurately. Once the m-tuples are obtained, they could then be stored in a hash-table or other data structure to keep track of which m-tuples have been used for question generation.

In general, the same approach may be used to identify the relationships embedded in a large language model and/or a prompt and extract them out for high quality generation on any topic. Typically, prompt engineering is the way to guide large language models to generate relevant high-quality response but even with prompts, users don't have any understanding of the underlying relationship in the text within the large language model and are trying to generate something that aligns with what the users want. Some of the approaches described herein not only provide insights into the relationships modeled by the large language model, but also provide a methodical way to drive the large language model to generate text across its entire domain or knowledge space. For example, to generate text on early childhood of Abraham Lincoln, the large language model may first be asked to generate keywords that correspond to the early childhood of Abraham Lincoln and then use those keywords and their relationships to extract all the information that LLM has internally available and get a complete picture.

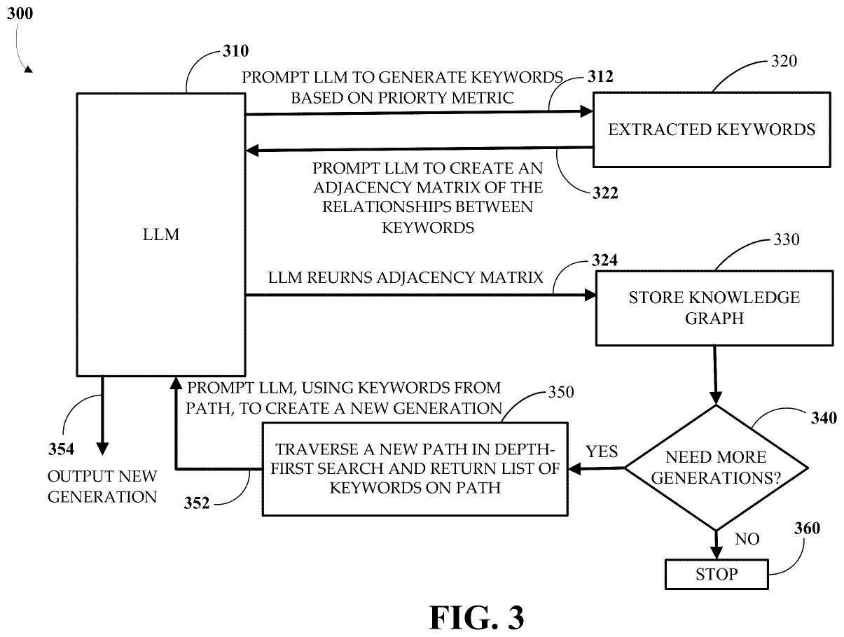

FIG. 3 is a block diagram of an example of a system 300 for stateful text generation using large language models. The system 300 is a more general purpose system that can be used to generate sets of distinct generations (e.g., texts) based on a list of keywords 320 for a context identified using a large language model 110. For example, the system 300 may be used to analyze a context including a set of contracts and describe relationships between important entities (e.g., parties and/or beneficiaries) in a detailed and comprehensive manner.

At 312, the large language model 310 is prompted to generate keywords 320 based on a priority metric (e.g., some measured notion of relevance to a topic). At 322, the large language model 310 is prompted to create an adjacency matrix of the relationships between the keywords 320. At 324, the large language model 310 returns the adjacency matrix, which is used to determine and store a graph 330 encoding these relationships in a searchable format. At 340, when a request for generations is processed and addition text is required, the system 300 traverses, at 350, a new path in the graph 330 using a depth-first search and returns a list or tuple of respective keywords corresponding to nodes on the new path. At 352, the large language model 310 is prompted using the new tuple of respective keywords for the new path to create a generation (e.g., a new text). At 354, the large language model 310 returns the new generation. This process may be repeated until 1) at 340, the required number of generations have been generated or 2) all nodes in the graph 330 have been marked complete. The process is completed and the resulting set of new generations may be returned to a user at 360.

### Refinement of the Keyword-Tuples

The system 300 may facilitate the intelligent organization of keyword-based tuples into meaningful clusters using embeddings generated via a text embedding model (e.g., OpenAI's text-embedding-ada-002 model). For example, the system 300 may apply K-means clustering to group of related tuples and utilize a combined metric of cosine similarity and Euclidean distance to select representative tuples for each cluster. Additionally, the system 300 may identify and remove redundant tuples by checking subset relationships, and updating database entries for deprecation as appropriate.

Some implementations may be tailored for large-scale educational datasets, aiming to enhance the structure and usability of keyword-tuple-based topics within a database. Some core components and processes refining a set of keyword tuples may include:
1. Embedding Generation:
   a. The system 300 may retrieve semantic embeddings for keyword tuples by sending concatenated keyword strings to an embedding API (e.g., OpenAI's embedding API).
   b. The embeddings may be stored along with their associated textual representations and indices to facilitate clustering and traceability.
2. K-Means Clustering:
   a. A configurable number of clusters (k) may be determined to segment the keyword tuples into meaningful groups.
   b. The clustering is performed on the embeddings, producing centroids and cluster assignments.
3. Representative Tuple Selection:
   a. Each cluster's centroid may serve as the reference point for identifying the tuple most representative of that cluster.
   b. A combined metric may be calculated for each tuple in a cluster using:
      i. Cosine Similarity: Measures the alignment between the tuple embedding and the cluster centroid.
      ii. Euclidean Distance: Measures the spatial closeness to the centroid, normalized to account for scaling.
   c. Weighting factors for similarity and distance may be configurable, and thresholds may be applied to ensure the selected tuple meets quality standards.
4. Redundancy Elimination:
   a. Subset relationships between tuples may be identified by comparing keyword lists. A smaller keyword list entirely contained in a larger one is marked redundant.
   b. Redundant tuples, particularly those linked to associated questions, are deprecated via updates to the database.
5. Database Integration:
   a. A database may be used as the backend to store and manage topics and their associated keyword tuples.
   b. Operations include:
      i. Fetching topics and keyword tuples exceeding a threshold count.
      ii. Updating tuples and marking deprecated entries when redundancy or lack of cluster representation is identified.
      iii. Tracking the completion of clustering tasks via a clustersCreated flag.
6. Scalability and Robustness:
   a. Embedding and clustering tasks may be designed to handle large-scale data sets efficiently.
   b. Error handling may ensure failed embedding generation does not halt the process, and logs may provide visibility into skipped operations.
   c. Database updates are atomic and fail-safe to preserve data integrity.

Some implementations of the system 300 may include some key functional enhancements, such as:
1. Configurable Clustering and Metrics:
   a. Parameters such as the number of clusters, similarity and distance weights, and thresholds may be adjusted to optimize results for different datasets or objectives.
2. Adaptive Tuple Pruning:
   a. The system 300 may intelligently reduce redundancy by leveraging semantic embeddings and set theory, ensuring minimal overlap while retaining representativeness.
3. Integration with Large Language Models and Databases:
   a. The system 300 may combine advanced AI capabilities with robust database operations for a seamless pipeline that transforms raw data into structured and actionable clusters.

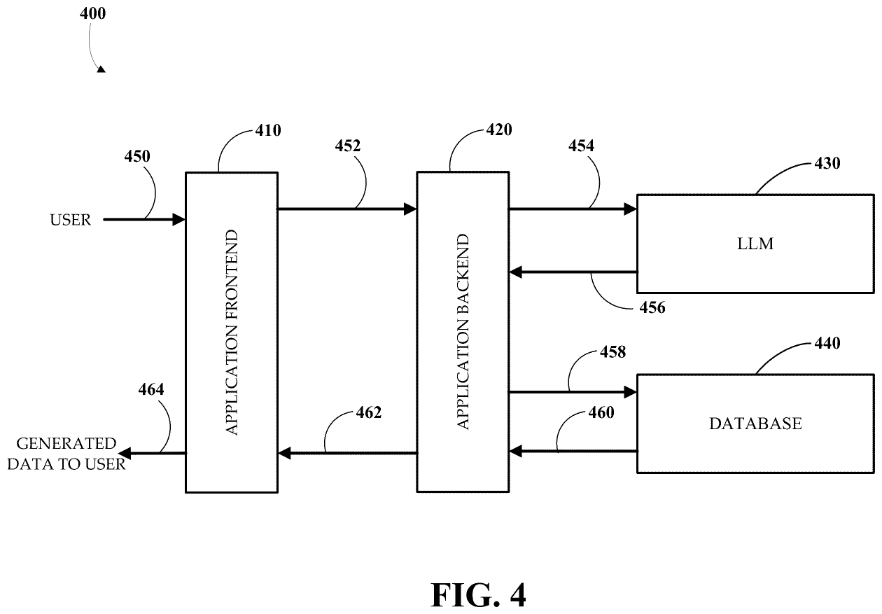

FIG. 4 is a block diagram of an example of a system 400 for stateful text generation using a large language model and a database. FIG. 4 describes the different components of the application and how they interact with each other. The application consists of the following components:
1. Application Frontend 410: This is the user interface with which the user interacts;
2. Application Backend 420: This implements the application programming interfaces (APIs) that the Frontend calls and the backend also interacts with the large language model 430 and the database 440;
3. Large Language Model 430: This could be a self-hosted or an LLM API from one of an external provider;
4. Database 440: This is the database that stores the results and other data

The flow of interaction and data transfer is as follows. At 450, a user calls the application frontend to request content to be generated. At 452, the application frontend 410 parses the request and calls the appropriate API in the application backend 420. A 454, the application backend 420 calls the large language model 430 with an appropriate prompt and context. At 456, the large language model 430 returns the generated text. At 458, the application backend 420 processes the large language model 430 generated text and stores the data that needs to be stored. At 460, if needed, the application backend 420 retrieves any other data from the database. At 462, the application backend 420 returns the API response with the appropriate data to the application frontend 410. At 464, the application frontend returns the response to the user.

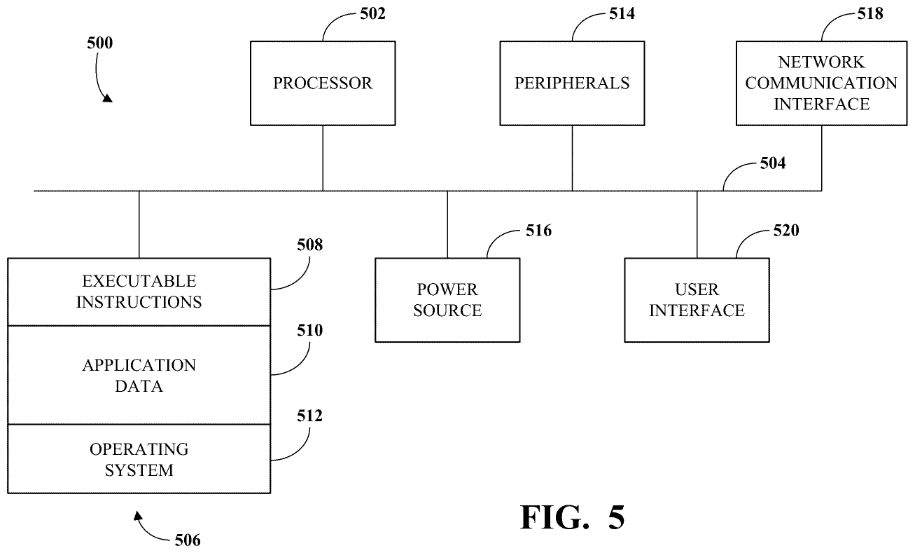

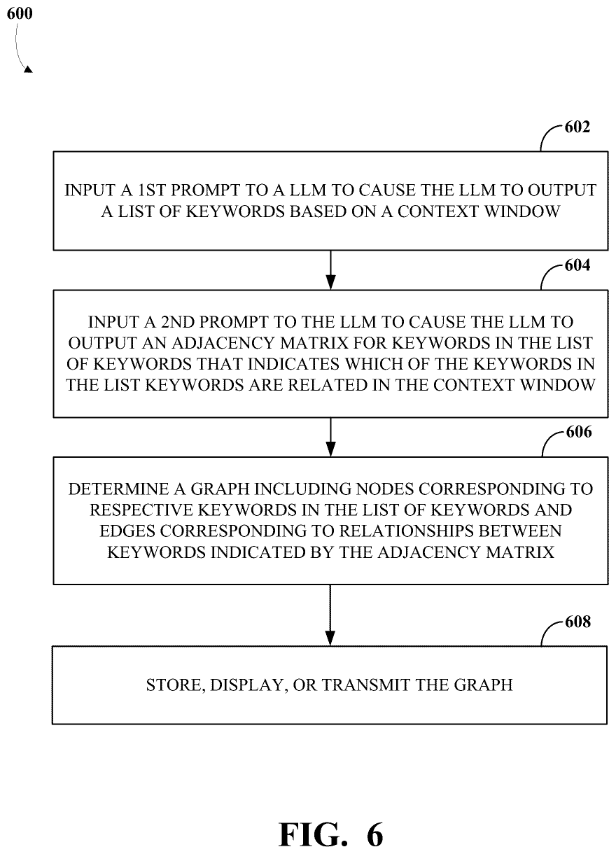

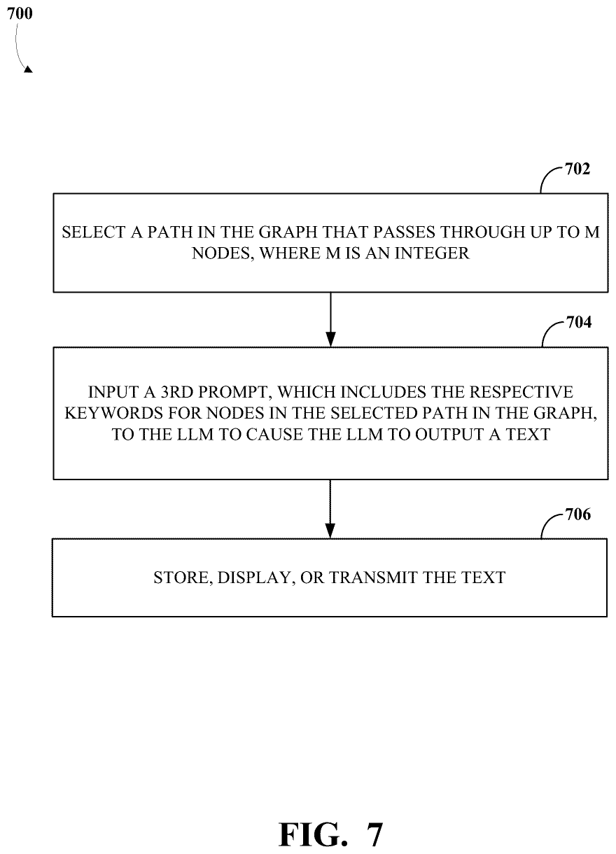

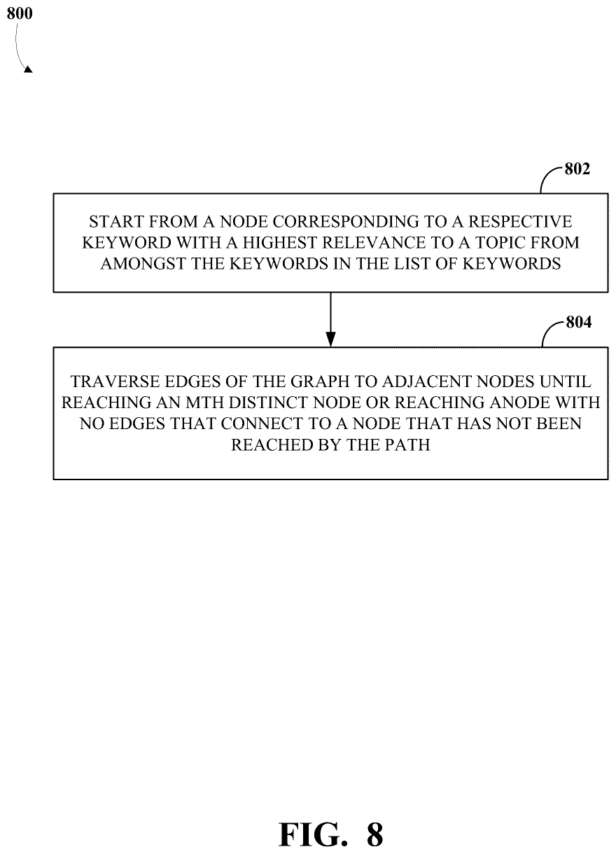

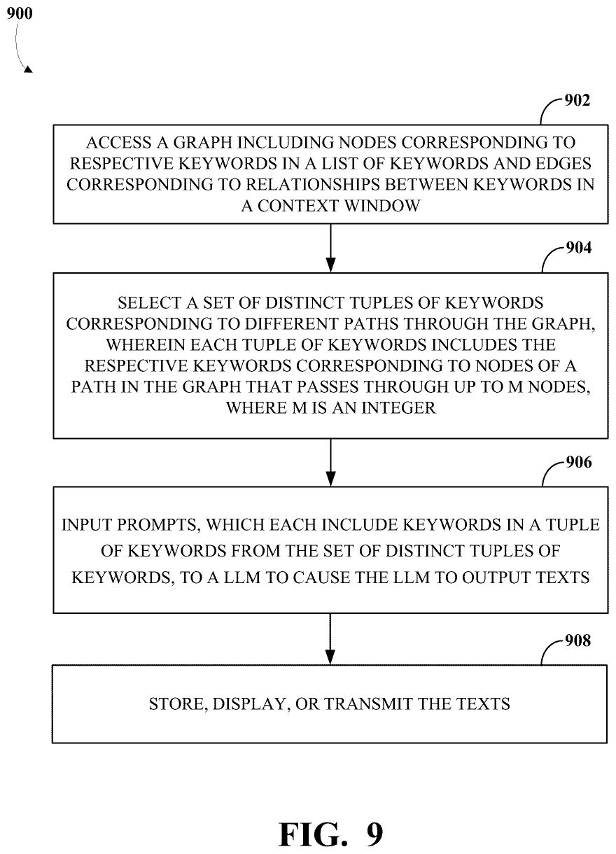

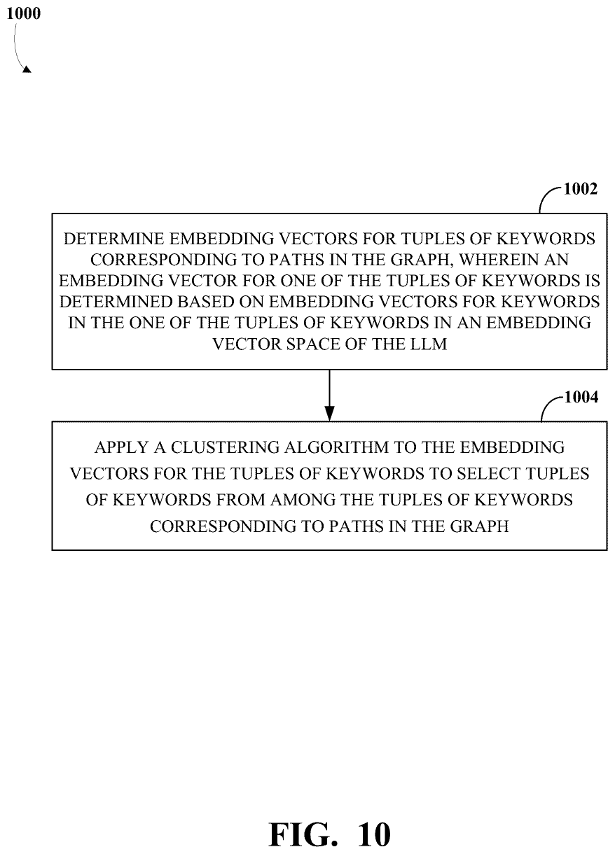

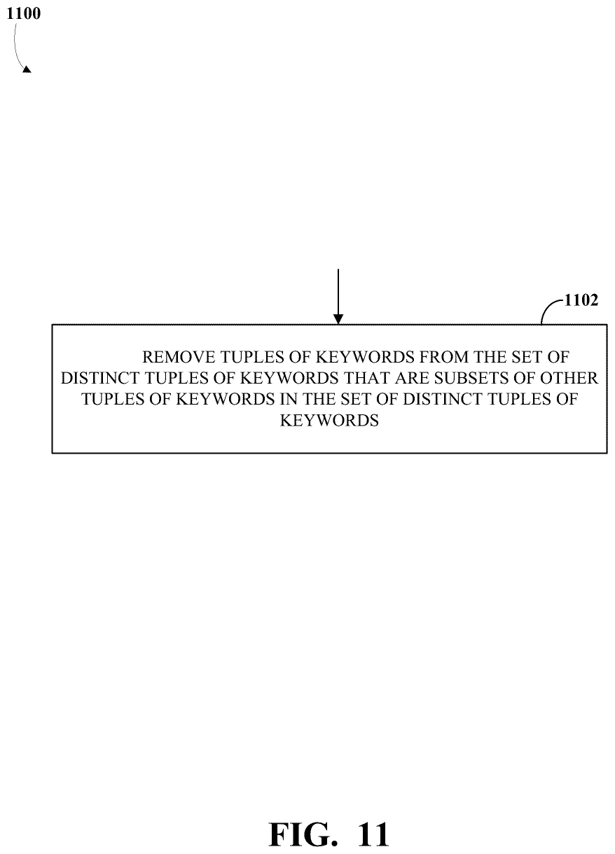

FIG. 5 is a block diagram of an example of a system for stateful text generation using large language models. The system 500 is an example of an internal configuration of a computing device that may be used to implement the system 100 as a whole or one or more components of the system 100 shown in FIG. 1. The system 500 may be used to implement the system 300 as a whole or one or more components of the system 300 shown in FIG. 3. The system 500 may be used to implement the system 400 as a whole or one or more components of the system 400 shown in FIG. 4. The system 500 may be used to implement the technique 600 of FIG. 6, the technique 700 of FIG. 7, the technique 800 of FIG. 8, the technique 900 of FIG. 9, the technique 1000 of FIG. 10, and/or the technique 1100 of FIG. 11. The system 500 can include components or units, such as a processor 502, a bus 504, a memory 506, peripherals 514, a power source 516, a network communication interface 518, a user interface 520, other suitable components, or a combination thereof.

The processor 502 can be a central processing unit (CPU), such as a microprocessor, and can include single or multiple processors having single or multiple processing cores. Alternatively, the processor 502 can include another type of device, or multiple devices, now existing or hereafter developed, capable of manipulating or processing information. For example, the processor 502 can include multiple processors interconnected in any manner, including hardwired or networked, including wirelessly networked. In some implementations, the operations of the processor 502 can be distributed across multiple physical devices or units that can be coupled directly or across a local area or other suitable type of network. In some implementations, the processor 502 can include a cache, or cache memory, for local storage of operating data or instructions.

The memory 506 can include volatile memory, non-volatile memory, or a combination thereof. For example, the memory 506 can include volatile memory, such as one or more DRAM modules such as DDR SDRAM, and non-volatile memory, such as a disk drive, a solid state drive, flash memory, Phase-Change Memory (PCM), or any form of non-volatile memory capable of persistent electronic information storage, such as in the absence of an active power supply. The memory 506 can include another type of device, or multiple devices, now existing or hereafter developed, capable of storing data or instructions for processing by the processor 502. The processor 502 can access or manipulate data in the memory 506 via the bus 504. Although shown as a single block in FIG. 5, the memory 506 can be implemented as multiple units. For example, a system 500 can include volatile memory, such as RAM, and persistent memory, such as a hard drive or other storage.

The memory 506 can include executable instructions 508, data, such as application data 510, an operating system 512, or a combination thereof, for immediate access by the processor 502. The executable instructions 508 can include, for example, one or more application programs, which can be loaded or copied, in whole or in part, from non-volatile memory to volatile memory to be executed by the processor 502. The executable instructions 508 can be organized into programmable modules or algorithms, functional programs, codes, code segments, or combinations thereof to perform various functions described herein. For example, the executable instructions 508 can include instructions executable by the processor 502 to cause the system 500 to automatically, in response to a command, generate an integrated circuit design and associated test results based on a design parameters data structure. The application data 510 can include, for example, user files, database catalogs or dictionaries, configuration information or functional programs, such as a web browser, a web server, a database server, or a combination thereof. The operating system 512 can be, for example, Microsoft Windows®, Mac OS X®, or Linux®; an operating system for a small device, such as a smartphone or tablet device; or an operating system for a large device, such as a mainframe computer. The memory 506 can comprise one or more devices and can utilize one or more types of storage, such as solid state or magnetic storage.

The peripherals 514 can be coupled to the processor 502 via the bus 504. The peripherals 514 can be sensors or detectors, or devices containing any number of sensors or detectors, which can monitor the system 500 itself or the environment around the system 500. For example, a system 500 can contain a temperature sensor for measuring temperatures of components of the system 500, such as the processor 502. Other sensors or detectors can be used with the system 500, as can be contemplated. In some implementations, the power source 516 can be a battery, and the system 500 can operate independently of an external power distribution system. Any of the components of the system 500, such as the peripherals 514 or the power source 516, can communicate with the processor 502 via the bus 504.

The network communication interface 518 can also be coupled to the processor 502 via the bus 504. In some implementations, the network communication interface 518 can comprise one or more transceivers. The network communication interface 518 can, for example, provide a connection or link to a network, such as a WiFi network or an Ethernet network, via a network interface, which can be a wired network interface, such as Ethernet, or a wireless network interface. For example, the system 500 can communicate with other devices via the network communication interface 518 and the network interface using one or more network protocols, such as Ethernet, TCP, IP, power line communication (PLC), WiFi, infrared, GPRS, GSM, CDMA, or other suitable protocols.

A user interface 520 can include a display; a positional input device, such as a mouse, touchpad, touchscreen, or the like; a keyboard; or other suitable human or machine interface devices. The user interface 520 can be coupled to the processor 502 via the bus 504. Other interface devices that permit a user to program or otherwise use the system 500 can be provided in addition to or as an alternative to a display. In some implementations, the user interface 520 can include a display, which can be a liquid crystal display (LCD), a cathode-ray tube (CRT), a light emitting diode (LED) display (e.g., an OLED display), or other suitable display. In some implementations, a client or server can omit the peripherals 514. The operations of the processor 502 can be distributed across multiple clients or servers, which can be coupled directly or across a local area or other suitable type of network. The memory 506 can be distributed across multiple clients or servers, such as network-based memory or memory in multiple clients or servers performing the operations of clients or servers. Although depicted here as a single bus, the bus 504 can be composed of multiple buses, which can be connected to one another through various bridges, controllers, or adapters.

FIG. 6 is flowchart of an example of a technique 600 for generating a knowledge graph indicating relationships amongst a list of keywords in a context using a large language model. The technique 600 includes inputting 602 a first prompt to a large language model to cause the large language model to output a list of keywords based on a context window; inputting 604 a second prompt to the large language model to cause the large language model to output an adjacency matrix for keywords in the list of keywords that indicates which of the keywords in the list of keywords are related in the context window; determining 606 a graph including nodes corresponding to respective keywords in the list of keywords and edges corresponding to relationships between keywords indicated by the adjacency matrix; and storing, displaying, or transmitting 608 the graph. For example, the technique 600 may be implemented using the system 100 of FIG. 1. For example, the technique 600 may be implemented using the system 300 of FIG. 3. For example, the technique 600 may be implemented using the system 400 of FIG. 4. For example, the technique 600 may be implemented using the system 500 of FIG. 5.

The technique 600 includes inputting 602 a first prompt to a large language model (e.g., Claude, Llama, ChatGPT, or Gemini) to cause the large language model to output a list of keywords based on a context window. For example, the large language model may use a transformer architecture with an attention mechanism and text embeddings. In some implementations, the context window may include one or more documents (e.g., documents associated with educational course or a collection of contracts or other legal documents) that are passed in the or pointed to by the first prompt. For example, the first prompt may be input 602 to the large language model via an application programming interface (API) of the large language model. For example, the first prompt may be input 602 to the large language model via an application web interface of the large language model. In some implementations, the first prompt causes the list of keywords to be ordered based on relevance to a topic occurring in one or more documents included in the context window. For example, the large language model may be prompted to order the list of keywords based on relevance metric. For example, in an application for generating test questions in an educational context, the first prompt may be created using the pseudo code snippet (1) below.

```
const get GenerateKeywordsListPrompt = ({ numKeywords, courseName,
unitName, topicName }) => {
  return ‘Generate ${numKeywords} keywords for the course
  ${courseName} on the Unit on ${unitName} and Topic of
  ${topicName} and return them in the decreasing order of probability
  of occurring in the ${courseName} exam.’
}
```

The technique 600 includes inputting 604 a second prompt to the large language model to cause the large language model to output an adjacency matrix for keywords in the list of keywords that indicates which of the keywords in the list of keywords are related in the context window. For example, the first prompt may be input 602 to the large language model via an application programming interface (API) of the large language model. For example, the first prompt may be input 602 to the large language model via an application web interface of the large language model. In some implementations, where the list of keywords includes N keywords, the adjacency matrix may be encoded as an N×N array, where each element is one or zero depending on whether the keyword correspond the row of the element and the keyword corresponding to column of the element are determined to be related by the large language model. In some implementations, the adjacency matrix may be encoded as an N×N array, where each element is a real number reflecting the nature of the relatedness of the keyword correspond the row of the element and the keyword corresponding to column of the element (e.g., the element value may be large if the keywords are strongly related and small if the keywords are weakly related), as determined by the large language model. In some implementations, elements on the diagonal of the adjacency matrix may ignored and/or omitted. In some implementations, the adjacency matrix may be encoded as a list of adjacency lists for each of the keywords. For example, if a keyword k_i is related to another keyword k_j, the large language model may add k_j to k_i's adjacency list and vice versa. For example, in an application for generating test questions in an educational context, the second prompt may be created using the pseudo code snippet (2) below.

```
const get GenerateAdjacencyMatrixPrompt = ({ KeywordList, courseName, unitName,
topicName }) => {
  return ‘Take the list of keywords below and identify relationships between them
  such that any two keywords are related to each other in the context of the topic:
  ${topicName} in the unit: ${unitName} of the course: ${courseName}. Make
  sure you identify only strong relationships between the keywords. Once you have
  identified the related keywords, create an adjacency list to capture the
  relationships such that the adjacency list for each keyword contains all keywords
  that it is related to and output the adjacency list.’
}
```

The technique 600 includes determining 606 a graph (e.g., the graph 200) including nodes corresponding to respective keywords in the list of keywords and edges corresponding to relationships between keywords indicated by the adjacency matrix. The information about relationships between the keywords in the adjacency matrix (e.g., adjacency lists) may be used to represent the keyword relationships in the form of a graph. In some implementations, the graph may have weighted edges, with weights determined 606 based on corresponding elements in the adjacency matrix. In some implementations, the graph may have edges without weights. For example, the graph may be determined 606 such that each keyword corresponds to a node and an edge between node n_i and n_j exists if the keyword corresponding to n_i is related to keyword corresponding to node n_j. A path on the graph may correspond to a set of related keywords. For example, determining 606 the graph may include comparing corresponding elements in the adjacency matrix to a threshold to determine whether or not a corresponding edge should exist in the graph. In some implementations, determining 606 the graph simply includes using the list of keywords as a node list and using the adjacency matrix as data structure listing the edges of the graph. In some implementations, the initial order (e.g., based on a relevance metric) of the respective keywords associated with the nodes may impose a topological ordering of the nodes.

The technique 600 includes storing, displaying, or transmitting 608 the graph. For example, the graph may be transmitted 608 to an external device (e.g., a smartphone, laptop, or tablet) for display or storage. For example, the graph may be transmitted 608 via the network communications interface 518. For example, the graph may be displayed 608 in the user interface 520. For example, the graph may be stored 608 in the memory 506. In some implementations, the graph may be stored 608 in the database 440.

Once the technique 600 has been used to create the graph using the large language model, the technique 700 and/or the technique 900 may also be implemented to use the graph with the large language model to generate distinct generations (e.g., texts) based on distinct tuples of keywords corresponding to nodes in selected paths in the graph. For example, the context window may include one or more documents that are materials for an educational course, and the generated texts may be test questions on a topic covered in the educational course. For example, the context window may include one or more documents that are contracts or other legal documents, and the generated texts may describe relationships and/or obligations between entities mentioned in the set of legal documents.

FIG. 7 is flowchart of an example of a technique 700 for stateful text generation using a large language model and a knowledge graph indicating relationships amongst a list of keywords in a context. The technique 700 includes selecting 702 a path in the graph that passes through up to M nodes, where M is an integer; inputting 704 a third prompt, which includes the respective keywords for nodes in the selected path in the graph, to the large language model to cause the large language model to output a text; and storing, displaying, or transmitting 706 the text. For example, the technique 700 may be implemented using the system 100 of FIG. 1. For example, the technique 700 may be implemented using the system 300 of FIG. 3. For example, the technique 700 may be implemented using the system 400 of FIG. 4. For example, the technique 700 may be implemented using the system 500 of FIG. 5.

The technique 700 includes selecting 702 a path in the graph (e.g., the graph 200) that passes through up to M nodes, where M is an integer. For example, a depth-first search starting from one of the nodes of the graph may be used to select the path. In some implementations, the nodes in the graph have an inherent ordering based on a relevance metric for respective keywords corresponding to the nodes in the graph, and the path may be selected 702 by starting from the lowest ordered node in the graph. For example, selecting 702 the path in the graph may include implementing the technique 800 of FIG. 8.

The technique 700 includes inputting 704 a third prompt, which includes the respective keywords for nodes in the selected path in the graph, to the large language model to cause the large language model to output a text. For example, the text may be a test question on a topic covered in an educational course.

The technique 700 includes storing, displaying, or transmitting 706 the text. For example, the text may be transmitted 706 to an external device (e.g., a smartphone, laptop, or tablet) for display or storage. For example, the text may be transmitted 706 via the network communications interface 518. For example, the text may be displayed 706 in the user interface 520. For example, the text may be stored 706 in the memory 506. In some implementations, the text may be stored 706 in the database 440.

In some implementations, the technique 700 is repeated for all paths starting from a first node. Once all paths of length M from the first node have been selected to determine respective tuples of keywords, the first node may be marked as complete (e.g., marked using meta data in the graph data structure). Once a node is marked complete, the next node in the topological order (e.g., the next node corresponding to the next keyword in the list of the keywords) may be used as a starting point for depth-first search to select additional paths in the graph. This process may be repeated until the required number of texts (e.g., test questions) have been generated or all nodes in the graph have been marked complete. In some implementations, a set of tuples of keywords corresponding to selected paths in the graph is curated (e.g., pruned) before they are used in prompts to the large language model to generate texts. For example, a set of tuples of keywords may be subjected to deduping operation to remove redundant tuples of keywords that consist of a same combination of keywords in a different order (i.e., corresponding the paths traversing a same set of nodes in a different order), where the order in which a set of keywords are presented in a prompt is not considered to be significant. For example, tuples of keywords may be eliminated from a set of tuples of keywords based on subset relationships between tuples. A smaller keyword list entirely contained in a larger one may be marked redundant. In some implementations, clustering algorithms (e.g., a k-means clustering algorithm) may be used to select a representative subset of a large set of tuples of keywords.

FIG. 8 is flowchart of an example of a technique 800 for selecting a path in a knowledge graph indicating relationships amongst a list of keywords in a context in order to select a tuple of keywords corresponding to the path. The technique 800 includes starting 802 from a node corresponding to a respective keyword with a highest relevance to a topic (e.g., a highest probability of appearing on an exam) from amongst the keywords in the list of keywords; and traversing 804 edges of the graph (e.g., the graph 200) to adjacent nodes until reaching an Mth distinct node or reaching a node with no edges that connect to a node that has not been reached by the path. For example, the technique 800 may be implemented using the system 100 of FIG. 1. For example, the technique 800 may be implemented using the system 300 of FIG. 3. For example, the technique 800 may be implemented using the system 400 of FIG. 4. For example, the technique 800 may be implemented using the system 500 of FIG. 5.

FIG. 9 is flowchart of an example of a technique 900 for selecting a set of distinct tuples of keywords that can be used with a large language model to generate a variety of texts that are relevant in a context. The technique 900 includes accessing 902 a graph including nodes corresponding to respective keywords in a list of keywords and edges corresponding to relationships between keywords in a context window; selecting 904 a set of distinct tuples of keywords corresponding to different paths through the graph, wherein each tuple of keywords includes the respective keywords corresponding to nodes of a path in the graph that passes through up to M nodes, where M is an integer; inputting 906 prompts, which each include the keywords in a tuple of keywords from the set of distinct tuples of keywords, to a large language model to cause the large language model to output texts; and storing, displaying, or transmitting 908 the texts. For example, the technique 900 may be implemented using the system 100 of FIG. 1. For example, the technique 900 may be implemented using the system 300 of FIG. 3. For example, the technique 900 may be implemented using the system 400 of FIG. 4. For example, the technique 900 may be implemented using the system 500 of FIG. 5.

The technique 900 includes accessing 902 a graph (e.g., the graph 200) including nodes corresponding to respective keywords in a list of keywords and edges corresponding to relationships between keywords in a context window. The list of keywords may have been determined using a large language model. For example, the graph may have been created using the technique 600 of FIG. 6. In some implementations, the context window includes one or more documents that are materials for an educational course. In some implementations, the context window includes one or more documents that are contracts or other legal documents. In some implementations, the graph may have weighted edges, with weights determined based on corresponding elements in an adjacency matrix for the list of keywords. In some implementations, the graph may have edges without weights. For example, the graph may be determined such that each keyword corresponds to a node and an edge between node n_i and n_j exists if the keyword corresponding to n_i is related to keyword corresponding to node n_j. A path on the graph may correspond to a set of related keywords. For example, the graph may be accessed 902 by receiving the indication of the graph (e.g., via network communications using the network communications interface 518). For example, the graph may be accessed 902 by reading the graph from memory (e.g., reading from the memory 506 via the bus 504).

The technique 900 includes selecting 904 a set of distinct tuples of keywords corresponding to different paths through the graph, wherein each tuple of keywords includes the respective keywords corresponding to nodes of a path in the graph that passes through up to M nodes, where M is an integer. In some implementations, tuples of keywords are considered distinct if they have different orders of the same combination of keywords, such as where a response of a large language model is expected to vary depending on the order in which the keywords are presented to the large language model within a prompt. In some implementations, tuples of keywords are considered distinct only if they have different combinations of keywords, such as where a response of a large language model is not expected to vary depending on the order in which the keywords are presented to the large language model within a prompt. Selecting 904 the set of distinct tuples of keywords may include searching (e.g., using a depth-first search) the graph from a starting node within the graph to select the path corresponding to one of the distinct tuples of keywords. For example, the technique 700 of FIG. 7 may be used select the path corresponding to one of the distinct tuples of keywords from the graph. In some implementations, there is an ordering (e.g., based on a relevance metric) of the respective keywords associated with the nodes, which may be used to prioritize and/or the nodes as starting points for search operations to select paths in the graph. In some implementations, all paths of length M starting from a first node are selected. Once all paths of length M from the first node have been selected to determine respective tuples of keywords, the first node may be marked as complete (e.g., marked using meta data in the graph data structure). Once a node is marked complete, a next node in the topological order (e.g., the next node corresponding to the next keyword in the list of the keywords) may be used as a starting point for depth-first search to select additional paths in the graph. This process may be repeated until the required number of texts (e.g., test questions) have been generated or all nodes in the graph have been marked complete. In some implementations, a set of tuples of keywords corresponding to selected paths in the graph is curated (e.g., pruned) before they are used in prompts to the large language model to generate texts. For example, a set of tuples of keywords may be subjected to deduping operation to remove redundant tuples of keywords that consist of a same combination of keywords in a different order (i.e., corresponding the paths traversing a same set of nodes in a different order), where the order in which a set of keywords are presented in a prompt is not considered to be significant. In some implementations, clustering algorithms (e.g., a k-means clustering algorithm) may be used to select a representative subset of a large set of tuples of keywords. For example, selecting 904 a set of distinct tuples of keywords corresponding to different paths through the graph may include implementing the technique 1000 of FIG. 10. For example, selecting 904 a set of distinct tuples of keywords corresponding to different paths through the graph may include implementing the technique 1100 of FIG. 11 to remove tuples of keywords from a set of tuples of keywords based on subset relationships between tuples.

The technique 900 includes inputting 906 prompts, which each include the keywords in a tuple of keywords from the set of distinct tuples of keywords, to a large language model (e.g., Claude, Llama, ChatGPT, or Gemini) to cause the large language model to output texts. For example, the texts may be test questions on a topic covered in an educational course. For example, the large language model may use a transformer architecture with an attention mechanism and text embeddings. In some implementations, the context window includes one or more documents that are materials for an educational course, and the texts are test questions on a topic covered in the educational course.

The technique 900 includes storing, displaying, or transmitting 908 the texts. For example, the texts may be transmitted 908 to an external device (e.g., a smartphone, laptop, or tablet) for display or storage. For example, the texts may be transmitted 908 via the network communications interface 518. For example, the texts may be displayed 908 in the user interface 520. For example, the texts may be stored 908 in the memory 506. In some implementations, the texts may be stored 908 in the database 440.

FIG. 10 is flowchart of an example of a technique 1000 for selecting a reduced set of distinct tuples of keywords using k-means analysis. The technique 1000 includes determining 1002 embedding vectors for tuples of keywords corresponding to paths in the graph, wherein an embedding vector for one of the tuples of keywords is determined based on embedding vectors for keywords in the one of the tuples of keywords in an embedding vector space of the large language model; and applying 1004 a clustering algorithm to the embedding vectors for the tuples of keywords to select tuples of keywords from among the tuples of keywords corresponding to paths in the graph. For example, the technique 1000 may be implemented using the system 500 of FIG. 5.

The technique 1000 includes determining 1002 embedding vectors for tuples of keywords corresponding to paths in the graph. An embedding vector for one of the tuples of keywords is determined based embedding vectors for keywords in the one of the tuples of keywords in an embedding vector space of the large language model. For example, the embedding vector for one of the tuples of keywords may be determined as a linear combination of embedding vectors for keywords in the one of the tuples of keywords in the embedding vector space of the large language model. In some implementations, semantic embeddings for keyword tuples may be determined 1002 by sending concatenated keyword strings to an embedding API (e.g., OpenAI's embedding API), which may be used by the large language model. The embedding vectors for tuples of keywords corresponding to paths in the graph may be stored along with their associated textual representations and indices to facilitate clustering and traceability.

The technique 1000 includes applying 1004 a clustering algorithm (e.g., a k-means algorithm) to the embedding vectors for the tuples of keywords to select tuples of keywords from among the tuples of keywords corresponding to paths in the graph. For example, applying 1004 a clustering algorithm to the embedding vectors may include applying a k-means algorithm to the embedding vectors for the tuples of keywords to select k tuples of keywords from the tuples of keywords corresponding to paths in the graph. In some implementations, a configurable number of clusters (k) may be determined to segment the keyword tuples into meaningful groups. The clustering may be performed on the embedding vectors, producing centroids and cluster assignments. One or more representative tuples of keywords may be selected from each of these identified clusters. For example, a cluster's centroid may serve as the reference point for identifying the one or more tuples most representative of that cluster. In some implementations, a combined metric may be calculated for each tuple in a cluster using cosine similarity and Euclidean distance with respect to a cluster centroid. Weighting factors for similarity and distance may be configurable. In some implementations, thresholds may be applied the combined metric and/or individual metrics to ensure the selected tuple meets quality standards.

FIG. 11 is flowchart of an example of a technique 1100 for selecting a reduced set of distinct tuples of keywords by removing tuples of keywords that are subsets of other tuples of keywords. The technique 1100 includes removing 1102 tuples of keywords that are from the set of distinct tuples of keywords that are subsets of other tuples of keywords in the set of distinct tuples of keywords. Subset relationships between tuples may be identified by comparing tuples of keywords. A smaller keyword tuple entirely contained in a larger one may be marked as redundant. In some implementations, redundant tuples of keywords, particularly those linked to associated texts (e.g., test questions), may be removed 1102 via updates to a database (e.g., the database 440). For example, the technique 1100 may be implemented using the system 100 of FIG. 1. For example, the technique 1100 may be implemented using the system 300 of FIG. 3. For example, the technique 1100 may be implemented using the system 400 of FIG. 4. For example, the technique 1100 may be implemented using the system 500 of FIG. 5.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A method comprising:
inputting a first prompt to a large language model to cause the large language model to output a list of keywords based on a context window;
inputting a second prompt to the large language model to cause the large language model to output an adjacency matrix for keywords in the list of keywords that indicates which of the keywords in the list of keywords are related in the context window;
determining a graph including nodes corresponding to respective keywords in the list of keywords and edges corresponding to relationships between keywords indicated by the adjacency matrix; and
storing, displaying, or transmitting the graph.

2. The method of claim 1, comprising:
selecting a path in the graph that passes through up to M nodes, where M is an integer;
inputting a third prompt, which includes the respective keywords for nodes in the selected path in the graph, to the large language model to cause the large language model to output a text; and
storing, displaying, or transmitting the text.

3. The method of claim 2, in which selecting the path in the graph comprises:
starting from a node corresponding to a respective keyword with a highest relevance to a topic from amongst the keywords in the list of keywords; and
traversing edges of the graph to adjacent nodes until reaching an Mth distinct node or reaching a node with no edges that connect to a node that has not been reached by the path.

4. The method of claim 1, comprising:
selecting a set of distinct tuples of keywords corresponding to different paths through the graph, wherein each tuple of keywords includes the respective keywords corresponding to nodes of a path in the graph that passes through up to M nodes, where M is an integer;
inputting prompts, which each include the keywords in a tuple of keywords from the set of distinct tuples of keywords, to the large language model to cause the large language model to output texts; and
storing, displaying, or transmitting the texts.

5. The method of claim 4, in which selecting the set of distinct tuples of keywords corresponding to different paths through the graph comprises:
determining embedding vectors for tuples of keywords corresponding to paths in the graph, wherein an embedding vector for one of the tuples of keywords is determined as a linear combination of embedding vectors for keywords in the one of the tuples of keywords in an embedding vector space of the large language model; and
applying a clustering algorithm to the embedding vectors for the tuples of keywords to select tuples of keywords from among the tuples of keywords corresponding to paths in the graph.

6. The method of claim 4, in which selecting the set of distinct tuples of keywords corresponding to different paths through the graph comprises:
removing tuples of keywords that are from the set of distinct tuples of keywords that are subsets of other tuples of keywords in the set of distinct tuples of keywords.

7. The method of claim 4, in which the context window includes one or more documents that are materials for an educational course, and the texts are test questions on a topic covered in the educational course.

8. The method of claim 1, in which the first prompt causes the list of keywords to be ordered based on relevance to a topic occurring in one or more documents included in the context window.

9. A system comprising:
a memory, and
a processor, wherein the memory includes instructions executable by the processor to cause the system to:
input a first prompt to a large language model to cause the large language model to output a list of keywords based on a context window;
input a second prompt to the large language model to cause the large language model to output an adjacency matrix for keywords in the list of keywords that indicates which of the keywords in the list of keywords are related in the context window; and
determine a graph including nodes corresponding to respective keywords in the list of keywords and edges corresponding to relationships between keywords indicated by the adjacency matrix.

10. The system of claim 9, wherein the memory includes instructions executable by the processor to cause the system to:
select a path in the graph that passes through up to M nodes, where M is an integer; and
input a third prompt, which includes the respective keywords for nodes in the selected path in the graph, to the large language model to cause the large language model to output a text.

11. The system of claim 10, wherein the memory includes instructions executable by the processor to cause the system to:
start from a node corresponding to a respective keyword with a highest relevance to a topic from amongst the keywords in the list of keywords; and
traverse edges of the graph to adjacent nodes until reaching an Mth distinct node or reaching a node with no edges that connect to a node that has not been reached by the path.

12. The system of claim 9, wherein the memory includes instructions executable by the processor to cause the system to:
select a set of distinct tuples of keywords corresponding to different paths through the graph, wherein each tuple of keywords includes the respective keywords corresponding to nodes of a path in the graph that passes through up to M nodes, where M is an integer; and
input prompts, which each include the keywords in a tuple of keywords from the set of distinct tuples of keywords, to the large language model to cause the large language model to output texts.

13. The system of claim 12, wherein the memory includes instructions executable by the processor to cause the system to:
determine embedding vectors for tuples of keywords corresponding to paths in the graph, wherein an embedding vector for one of the tuples of keywords is determined as a linear combination of embedding vectors for keywords in the one of the tuples of keywords in an embedding vector space of the large language model; and
apply a clustering algorithm to the embedding vectors for the tuples of keywords to select tuples of keywords from among the tuples of keywords corresponding to paths in the graph.

14. The system of claim 12, wherein the memory includes instructions executable by the processor to cause the system to:
remove tuples of keywords that are from the set of distinct tuples of keywords that are subsets of other tuples of keywords in the set of distinct tuples of keywords.

15. The system of claim 12, in which the context window includes one or more documents that are materials for an educational course, and the texts are test questions on a topic covered in the educational course.

16. The system of claim 9, in which the first prompt causes the list of keywords to be ordered based on relevance to a topic occurring in one or more documents included in the context window.

17. A method comprising:
accessing a graph including nodes corresponding to respective keywords in a list of keywords and edges corresponding to relationships between keywords in a context window;
selecting a set of distinct tuples of keywords corresponding to different paths through the graph, wherein each tuple of keywords includes the respective keywords corresponding to nodes of a path in the graph that passes through up to M nodes, where M is an integer;
inputting prompts, which each include the keywords in a tuple of keywords from the set of distinct tuples of keywords, to a large language model to cause the large language model to output texts; and
storing, displaying, or transmitting the texts.

18. The method of claim 17, in which selecting the set of distinct tuples of keywords corresponding to different paths through the graph comprises:
determining embedding vectors for tuples of keywords corresponding to paths in the graph, wherein an embedding vector for one of the tuples of keywords is determined as a linear combination of embedding vectors for keywords in the one of the tuples of keywords in an embedding vector space of the large language model; and
applying a clustering algorithm to the embedding vectors for the tuples of keywords to select tuples of keywords from among the tuples of keywords corresponding to paths in the graph.

19. The method of claim 17, in which selecting the set of distinct tuples of keywords corresponding to different paths through the graph comprises:
removing tuples of keywords that are from the set of distinct tuples of keywords that are subsets of other tuples of keywords in the set of distinct tuples of keywords.

20. The method of claim 17, in which the context window includes one or more documents that are materials for an educational course, and the texts are test questions on a topic covered in the educational course.
